(19) United States
(12) Patent Application Publication
(10) Pub. No.: US 2003/0182511 A1
(43) Pub. Date: Sep. 25, 2003

(54) Apparatus and method for resolving an instruction conflict in a software pipeline nested loop procedure in a digital signal processor

(76) Inventors: Michael D. Asal, Austin, TX (US); Eric J. Stotzer, Houston, TX (US)

Correspondence Address: TEXAS INSTRUMENTS INCORPORATED, P O BOX 655474, M/S 3999, DALLAS, TX, 75265

(21) Appl. No.: 10/225,035

(22) Filed: Aug. 21, 2002

Related U.S. Application Data
(60) Provisional application No. 60/342,706, filed on Dec. 20, 2001.
(60) Provisional application No. 60/342,728, filed on Dec. 20, 2001.

(51) Int. Cl. G06F 12/00

(52) U.S. Cl. 711/125; 711/156

(57) ABSTRACT

A program memory controller unit includes apparatus for the execution of a software pipeline procedure in response to a predetermined instruction. The apparatus provides a prolog, a kernel, and an epilog state for the execution of the software pipeline procedure. In addition, in response to a predetermined condition, the software pipeline procedure can be terminated early. A second software procedure can be initiated prior to the completion of first software procedure. The apparatus can execute an inner nested loop of a nested loop instruction set as a software pipeline procedure. The inner nested loop instruction set is stored in a buffer memory unit during the execution of the outer nested loop instruction set. The epilog of the inner nested loop instruction set can overlap the execution of the outer loop instruction set and the execution of the prolog of the next inner nested loop procedure. Apparatus is provided for resolution of instruction conflict in overlapping inner loop and outer loop instruction execution.

This application claims priority from provisional patent application No. 60/342,706 entitled APPARATUS AND METHOD FOR A SOFTWARE PIPELINE LOOP PROCEDURE IN A DIGITAL SIGNAL PROCESSOR, invented by Eric J. Stotzer, Steve D. Krueger, and Timothy D. Anderson, filed on Dec. 20, 2001, and assigned to the assignee of the present Application: and provisional patent application No. 60/342,728 entitled APPARATUS ANDMETHOD FOR IMPROVED EXECUTION OF A SOFTWARE PIPELINE LOOP PROCEDURE IN A DIGITAL SIGNAL PROCESSOR, invented by Timothy D. Anderson, Michael D. Asal, and Eric J. Stotzer, filed on Dec. 20, 2001, and assigned to the assignee of the present Application:

### RELATED APPLICATION

U.S. patent application Ser. No. 09/855,140 (Attorney Docket TI-25737) entitled LOOP CACHE MEMORY AND CACHE CONTROLLER FOR PIPELINED MICROPROCESSORS, invented by Richard H. Scales, filed on May 14, 2001, and assigned to the assignee of the present application: U.S. patent application (Attorney Docket TI-33895), entitled APPARATUS AND METHOD FOR A SOFTWARE PIPELINE LOOP PROCEDURE IN A DIGITAL SIGNAL PROCESSOR, invented by Eric J. Stotzer, Steve D. Krueger, and Timothy D. Anderson, filed on even date herewith, and assigned to the assignee of the present Application: U.S. patent application (Attorney Docket TI-33896), entitled APPARATUS ANDMETHOD FOR IMPROVED EXECUTION OF A SOFTWARE PIPELINE LOOP PROCEDURE IN A DIGITAL SIGNAL PROCESSOR, invented by Timothy D. Anderson, Michael D. Asal, and Eric J. Stotzer, filed on even date herewith, and assigned to the assignee of the present Application: U.S. patent application (Attorney Docket TI-34336), entitled APPARATUS AND METHOD FOR PROCESSING AN INTERRUPT IN A SOFTWARE PIPELINE LOOP PROCEDURE IN A DIGITAL SIGNAL PROCESSOR, invented by Eric J. Stotzer, Steve D. Krueger, Timothy D. Anderson, and Michael D. Asal filed on even date herewith, and assigned to the assignee of the present Application: U.S. patent (Attorney Docket TI-34337), entitled APPARATUS AND METHOD FOR EXECUTING A NESTED LOOP PROGRAM WITH A SOFTWARE PIPELINE LOOP PROCEDURE IN A DIGITAL SIGNAL PROCESSOR, invented by Eric J. Stotzer and Michael D. Asal, filed on even date herewith, and assigned to the assignee of the present Application; and U.S. patent application (Attorney Docket TI-34335) entitled APPARATUS AND METHOD FOR EXITING FROM A SOFTWARE PIPELINE LOOP PROCEDURE IN A DIGITAL SIGNAL PROCESSOR, invented by Elana D Granston, Eric J. Stotzer Steve D. Krueger, and Timothy D. Anderson, filed on even date herewith and assigned to the assignee of the present application are related applications.

### BACKGROUND OF THE INVENTION

1. Field of the Invention

This invention relates generally to the execution of instructions in a digital signal processor, and more particularly to the execution of instructions in a software pipeline loop.

2. Background of the Invention

A microprocessor is a circuit that combines the instruction-handling, arithmetic, and logical operations of a computer on a single chip. A digital signal processor (DSP) is a microprocessor optimized to handle large volumes of data efficiently. Such processors are central to the operation of many of today's electronic products, such as high-speed modems, high-density disk drives, digital cellular phones, and complex automotive systems, and will enable a wide variety of other digital systems in the future. The demands placed upon DSPs in these environments continue to grow as consumers seek increased performance from their digital products.

Designers have succeeded in increasing the performance of DSPs generally by increasing clock frequencies, by removing architectural bottlenecks in DSP circuit design, by incorporating multiple execution units on a single processor circuit, and by developing optimizing compilers that schedule operations to be executed by the processor in an efficient manner. As further increases in clock frequency become more difficult to achieve, designers have implemented the multiple execution unit processor as a means of achieving enhanced DSP performance. For example, FIG. 1 shows a block diagram of a DSP execution unit and register structure having eight execution units, L1, S1, M1, D1, L2, S2, M2, and D2. These execution units operate in parallel to perform multiple operations, such as addition, multiplication, addressing, logic functions, and data storage and retrieval, simultaneously.

The Texas Instruments TMS320C6x (C6x) processor family comprises several embodiments of a processor that may be modified advantageously to incorporate the present invention. The C6x family includes both scalar and floating-point architectures. The CPU core of these processors contains eight execution units, each of which requires a 31-bit instruction. If all eight execution units of a processor are issued an instruction for a given clock cycle, the maximum instruction word length of 256 bits (831-bit instructions plus 8 bits indicating parallel sequencing) is required.

A block diagram of a C6x processor connected to several external data systems is shown in FIG. 1. Processor 10 comprises a CPU core 20 in communication with program memory controller 30 and data memory controller 12. Other significant blocks of the processor include peripherals 14, a peripheral bus controller 17, and a DMA controller 18.

Processor 10 is configured such that CPU core 20 need not be concerned with whether data and instructions requested from memory controllers 12 and 30 actually reside on-chip or off-chip. If requested data resides on chip, controller 12 or 30 will retrieve the data from respective on-chip data memory 13 or program memory/cache 31. If the requested data does not reside on-chip, these units request the data from external memory interface (EMIF) 16. EMIF 16 communicates with external data bus 70, which may be connected to external data storage units such as a disk 71, ROM 72, or RAM 73. External data bus 70 is 32 bits wide.

CPU core 20 includes two generally similar data paths 24a and 24b, as shown in FIG. 1 and detailed in FIGS. 2a and 2b. The first path includes a shared multiport register file A and four execution units, including an arithmetic and load/store unit D1, an arithmetic and shifter unit S1, a multiplier M1, and an arithmetic unit L1. The second path includes multiport register file B and execution units arithmetic unit L2, shifter unit S2, multiplier M2, and load/store unit D2. Capability (although limited) exists for sharing data across these two data paths.

Because CPU core 20 contains eight execution units, instruction handling is an important function of CPU core 20. Groups of instructions, 256 bits wide, are requested by program fetch 21 and received from program memory controller 30 as fetch packets, i.e. 100, 200, 300, 400, where each fetch packet is 32 bits wide. Instruction dispatch 22 distributes instructions from fetch packets among the execution units as execute packets, forwarding the “ADD” instruction to the arithmetic unit, L1 or the arithmetic unit L2, the “MPY” instruction to either Multiplier unit M1 or M2, the “ADDK” instruction to either arithmetic and shifter units S1 or S2 and the “STW” instruction to either arithmetic and load/store units, D1 and D2. Subsequent to instruction dispatch 22, instruction decode 23 decodes the instructions, prior to application to the respective execute unit.

Theoretically, the performance of a multiple execution unit processor is proportional to the number of execution units available. However, utilization of this performance advantage depends on the efficient scheduling of operations such that most of the execution units have a task to perform each clock cycle. Efficient scheduling is particularly important for looped instructions, since in a typical runtime application the processor will spend the majority of its time in loop execution.

Traditionally, the compiler is the piece of software that performs the scheduling operations. The compiler is the piece of software that translates source code, such as C, BASIC, or FORTRAN, into a binary image that actually runs on a machine. Typically the compiler consists of multiple distinct phases. One phase is referred to as the front end, and is responsible for checking the syntactic correctness of the source code. If the compiler is a C compiler, it is necessary to make sure that the code is legal C code. There is also a code generation phase, and the interface between the front-end and the code generator is a high level intermediate representation. The high level intermediate representation is a more refined series of instructions that need to be carried out. For instance, a loop might be coded at the source level as: for(I=0,I<10,I=I+1), which might in fact be broken down into a series of steps, e.g. each time through the loop, first load up I and check it against 10 to decide whether to execute the next iteration.

A code generator of the code generator phase takes this high level intermediate representation and transforms it into a low level intermediate representation. This is closer to the actual instructions that the computer understands. An optimizer component of a compiler must preserve the program semantics (i.e. the meaning of the instructions that are translated from source code to an high level intermediate representation, and thence to a low level intermediate representation and ultimately an executable file), but rewrites or transforms the code in a way that allows the computer to execute an equivalent set of instructions in less time.

Source programs translated into machine code by compilers consists of loops, e.g. DO loops, FOR loops, and WHILE loops. Optimizing the compilation of such loops can have a major effect on the run time performance of the program generated by the compiler. In some cases, a significant amount of time is spent doing such bookkeeping functions as loop iteration and branching, as opposed to the computations that are performed within the loop itself. These loops often implement scientific applications that manipulate large arrays and data instructions, and run on high speed processors. This is particularly true on modern processors, such as RISC architecture machines. The design of these processors is such that in general the arithmetic operations operate a lot faster than memory fetch operations. This mismatch between processor and memory speed is a very significant factor in limiting the performance of microprocessors. Also, branch instructions, both conditional and unconditional, have an increasing effect on the performance of programs. This is because most modern architectures are super-pipelined and have some sort of a branch prediction algorithm implemented. The aggressive pipelining makes the branch misprediction penalty very high. Arithmetic instructions are interregister instructions that can execute quickly, while the branch instructions, because of mispredictions, and memory instructions such as loads and stores, because of slower memory speeds, can take a longer time to execute.

One effective way in which looped instructions can be arranged to take advantage of multiple execution units is with a software pipelined loop. In a conventional scalar loop, all instructions execute for a single iteration before any instructions execute for following iterations. In a software pipelined loop, the order of operations is rescheduled such that one or more iterations of the original loop begin execution before the preceding iteration has finished. Referring to FIG. 5, a simple scalar loop containing 20 iterations of the loop of instructions A, B, C, D and E is shown. FIG. 6 depicts an alternative execution schedule for the loop of FIG. 5, where a new iteration of the original loop is begun each clock cycle. For clock cycles I₄-I₁₉, the same instruction (Aₙ,Bₙ₋₁,Cₙ₋₂,Dₙ₋₃,Eₙ₋₄) is executed each clock cycle in this schedule. If multiple execution units are available to execute these operations in parallel, the code can be restructured to perform this repeated instruction in a loop. The repeating pattern of A,B,C,D,E (along with loop control operations) thus forms the loop kernel of a new, software pipelined loop that executes the instructions at clock cycles I₄-I₁₉ in 16 loops. The instructions executed at clock cycles I₁ through I₃ of FIG. 8 must still be executed first in order to properly “fill” the software pipelined loop; these instructions are referred to as the loop prolog. Likewise, the instructions executed at clock cycles I₂₀ and I₂₃ of FIG. 2 must still be executed in order to properly “drain” the software pipeline; these instructions are referred to as the loop epilog (note that in many situations the loop epilog may be deleted through a technique known as speculative execution).

The simple example of FIGS. 5 and 6 illustrates the basic principles of software pipelining, but other considerations such as dependencies and conflicts may constrain a particular scheduling solution. For an explanation of software pipelining in more detail, see Vicki H. Allan, Software Pipelining, 27 ACM Computing Surveys 367 (1995). An example of software pipeline techniques is given in U.S. Pat. No. 6,178,499 B1, entitled INTERRUPTABLE MULTIPLE EXECUTION UNIT PROCESSING DURING OPERATIONS UTILIZING MULTIPLE ASSIGNMENT OF REGISTERS, issued Jan. 23, 2001, invented by Stotzer et al. and assigned to the assignee of the present application.

One disadvantage of software pipelining is the need for a specialized loop prolog for each loop. The loop prolog explicitly sequences the initiation of the first several iterations of a pipeline, until the steady-state loop kernel can be entered (this is commonly called “filling” the pipeline). Steady-state operation is achieved only after every instruction in the loop kernel will have valid operands if the kernel is executed. As a rule of thumb, the loop kernel can be executed in steady state after k=l−m clock cycles, where l represents the number of clock cycles required to complete one iteration of the pipelined loop, and m represents the number of clock cycles contained in one iteration of the loop kernel (this formula must generally be modified if the kernel is unrolled).

Given this relationship, it can be appreciated that as the cumulative pipeline delay required by a single iteration of a pipelined loop increases, corresponding increases in loop prolog length are usually observed. In some cases, the loop prolog code required to fill the pipeline may be several times the size of the loop kernel code. As code size can be a determining factor in execution speed (shorter programs can generally use on-chip program memory to a greater extent than longer programs), long loop prologs can be detrimental to program execution speed. An additional disadvantage of longer code is increased power consumption—memory fetching generally requires far more power than CPU core operation.

One solution to the problem of long loop prologs is to “prime” the loop. That is, to remove the prolog and execute the loop more times. To do this, certain instructions such as stores, should not execute the first few times the loop is executed, but instead execute the last time the loop is executed. This could be accomplished by making those instructions conditional and allocating a new counter for every group of instructions that should begin executing on each particular loop iteration. This, however, adds instructions for the decrement of each new loop counter, which could cause lower loop performance. It also adds code size and extra register pressure on both general purpose registers and conditional registers. Because of these problems, priming a software pipelined loop is not always possible or desirable.

In addition, after the kernel has been executed, the need arises for efficient execution of the epilog of the software pipeline, a procedure referred to as “draining” the pipeline.

A need has therefore been felt for apparatus and an associated method having the feature that the code size, power consumption, and processing delays are reduced in the execution of a software pipeline procedure. It is a further feature of the apparatus and associated method to provide a plurality of instruction stages for the software pipelined program, the instruction stages each including at least one instruction, wherein all of the stages can be executed simultaneously without conflict. It is a more particular feature of the apparatus and associated method to provide a program memory controller that can execute the prolog, kernel, and epilog of the software pipeline program. It is further particular feature of the apparatus and associated method to execute a prolog procedure, a kernel procedure, and an epilog procedure for a sequence of instructions in response to an instruction. It is yet another feature of the apparatus and associated method to provide for an early exit of the pipeline software procedure in response to a predetermined condition. It is a still further feature of the apparatus and associated method to begin execution of a second software pipeline procedure prior to completion of a first software pipeline procedure. It is still another feature of the apparatus and associated method to provide an improved execution of a nested-loop software program. It is a still further feature of the apparatus and associated method to store the inner loop instruction stages in the buffer storage unit during the execution of the outer loop instruction stages. It is yet another feature of the present invention to store the outer loop instruction stages in a buffer storage unit. It is a still further feature of the apparatus and associated method to provide for overlap of the execution of the inner loop and outer loop program execution. It is yet another feature of the apparatus and associated method to provide for a resolution of an instruction conflict in the overlapping inner loop and outer loop instruction execution.

### SUMMARY OF THE INVENTION

The aforementioned and other features are accomplished, according to the present invention, by providing a program memory controller unit of a digital signal processor with apparatus for executing a sequence of instructions as a software pipeline procedure in response to an instruction. The instruction includes the parameters needed to implement the software pipeline procedure without additional software intervention. The apparatus includes a dispatch buffer unit that stores the sequence of instruction stages as these instruction stages are retrieved from the program memory/cache unit during a prolog state. The program memory controller unit, as each instruction stage is withdrawn from the program memory/cache, applies the instruction stage to a decode/execution unit via a dispatch crossbar unit and stores the instruction in a dispatch buffer unit. The stored instruction stages are applied, along with the instruction stage withdrawn from the program memory/cache unit, to the dispatch crossbar unit. When all of the instruction stages (or the kernel) have been stored in the dispatch buffer unit, then program memory controller unit causes all of the stages stored in the dispatch buffer unit to be applied to the dispatch crossbar unit simultaneously thereafter. When the number of repetitions of the first stage is the number of repetitions to be performed by the software pipeline, then the program controller unit begins implementing the epilog state and draining each instruction from the dispatch buffer unit after each instruction has been processed the preselected number of repetitions. The software pipeline procedure can be used to execute a nested loop instruction set. By leaving the inner loop instruction stages in the dispatch buffer unit during the execution of the outer loop instructions, the nested loop instruction set can be executed more efficiently by reusing the inner loop instructions from the dispatch buffer unit. Further execution efficiency of the nested loop instructions can be obtained by the storing the outer loop instruction stages in a buffer register associated with the program execution unit. Apparatus is provided so that a conflict in instructions in the overlap of the inner loop and outer loop instruction execution in a nested loop program can be resolved.

Other features and advantages of present invention will be more clearly understood upon reading of the following description and the accompanying drawings and the claims.

### BRIEF DESCRIPTION OF THE DRAWINGS

FIG. 1 is a block diagram depicting the execution units and registers of a multiple-execution unit processor, such as the Texas Instruments C6x microprocessor on which a preferred embodiment of the current invention is operable to execute.

FIG. 2a illustrates in a more detailed block diagram form, the flow of fetch packets as received from program memory 30 through the stages of fetch 21, dispatch 22, decode 23, and the two data paths 1 and 2, 24a and 24b; while FIG. 2b illustrates in detail the data paths 1, 24a, and 2, 24b of FIGS. 1 and 2.

FIG. 3 illustrates the C6000 pipeline stages on which the current invention is manifested as an illustration.

FIG. 4 illustrates the Hardware Pipeline for a sequence of 5 instructions executed serially.

FIG. 5 illustrates the same 5 instructions executed in a single cycle loop with 20 iterations with serial execution, no parallelism and no software pipelining.

FIG. 6 illustrates the same 5 instructions executed in a loop with 20 iterations with software pipelining.

FIG. 7A illustrates the states of a state machine capable of implementing the software program loop procedures according to the present invention; FIG. 7B illustrates principal components of the program memory control unit used in software pipeline loop implementation according to the present invention; and FIG. 7C illustrates the principal components of a dispatch buffer unit according to the present invention.

FIG. 8 illustrates the instruction set of a software pipeline procedure according to the present invention.

FIG. 9 illustrates the application of the instruction stage to the dispatch crossbar unit according to the present invention.

FIG. 10A is a flowchart illustrating the SPL_IDLE execution response to a SPLOOP instruction, FIG. 10B(1) and FIG. 10B(2) illustrate SPL_PROLOG state response to an SPLOOP instruction, FIG. 10C illustrates the SPL_KERNEL state response to a SPLOOP instruction, FIG. 10D(1) and FIG. 10D(2) illustrate the response of an SPL_EPILOG state to a SPLOOP instruction, FIG. 10E illustrates the response of the SPL_EARLY_EXIT state to a SPLOOP instruction, and FIG. 10F(1) and FIG. 10F(2) illustrate the response of the SPL_OVERLAP state according to the present invention.

FIG. 11A illustrates a software pipeline loop for a group of five instructions, while FIG. 11B illustrates an SPL_EARLY_EXIT for the same group of instructions.

FIG. 12A illustrates a nested-loop sequence of software instructions, while FIG. 12B illustrates how the nested-loop instructions can be executed using a software pipeline procedure.

FIG. 13 illustrates the process of FIG. 12B wherein the inner loop is implemented by a software pipeline process.

FIG. 14A FIG. 14B illustrate apparatus for performing the nested-loop procedure in an efficient manner.

FIG. 15 illustrates the conflict between an execution packet in the inner loop epilog instruction and the outer loop instruction set.

FIG. 16 is a block diagram of the apparatus for resolving the conflict between an execution packet in the inner loop epilog and the outer loop program according to the present invention.

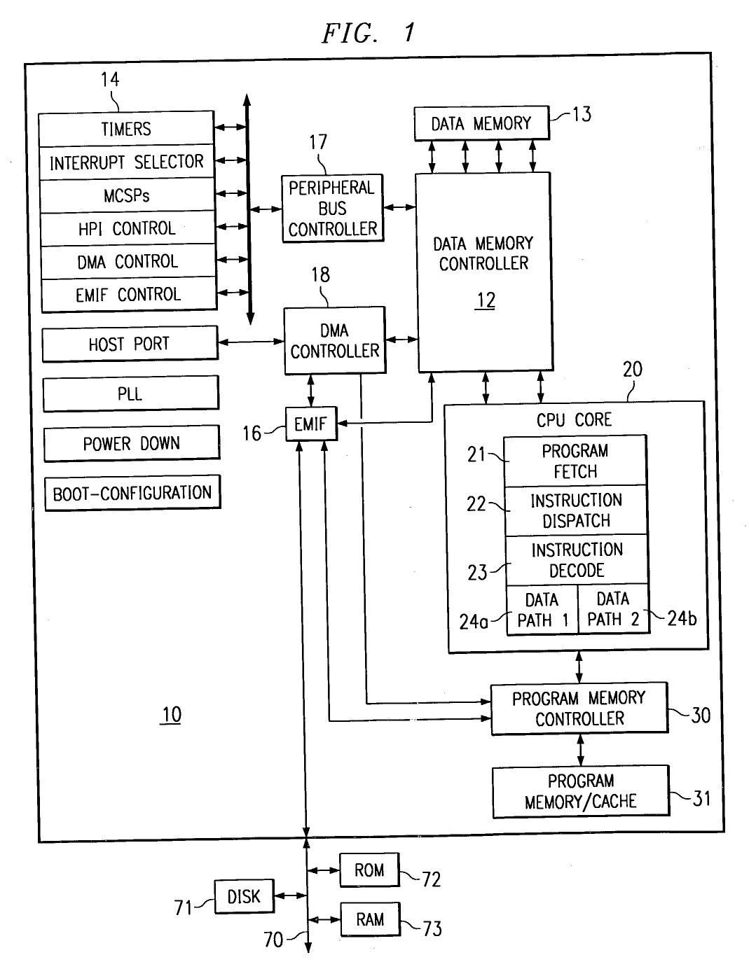

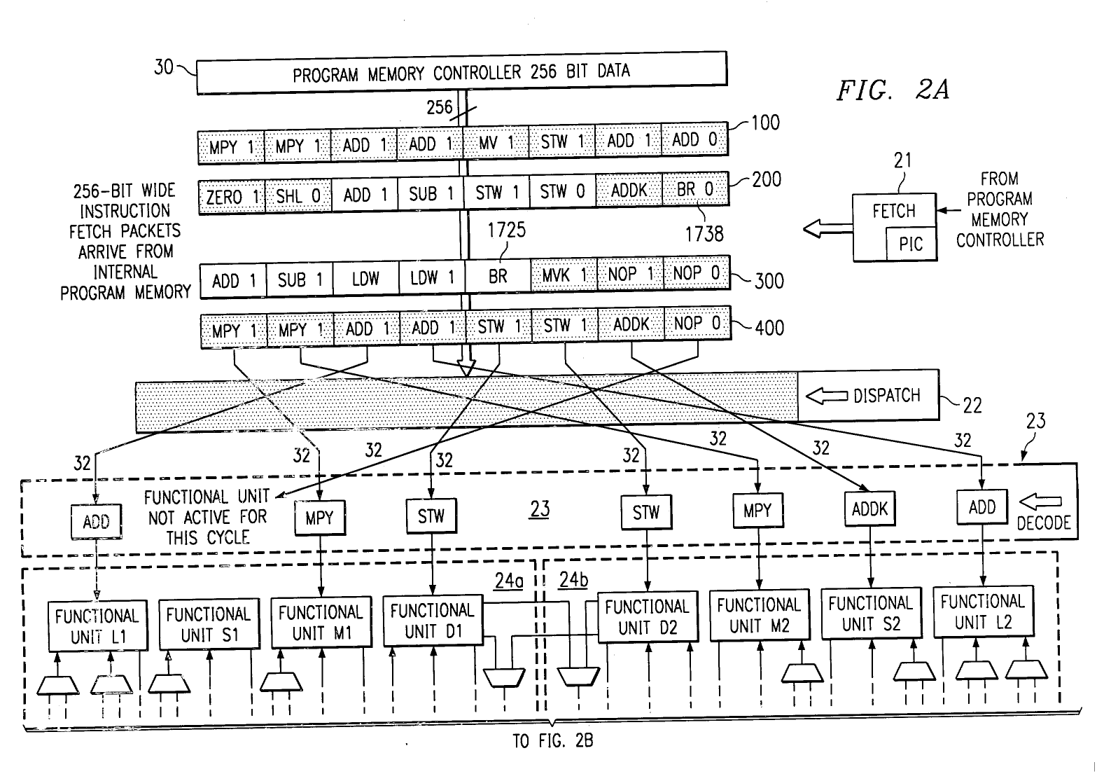

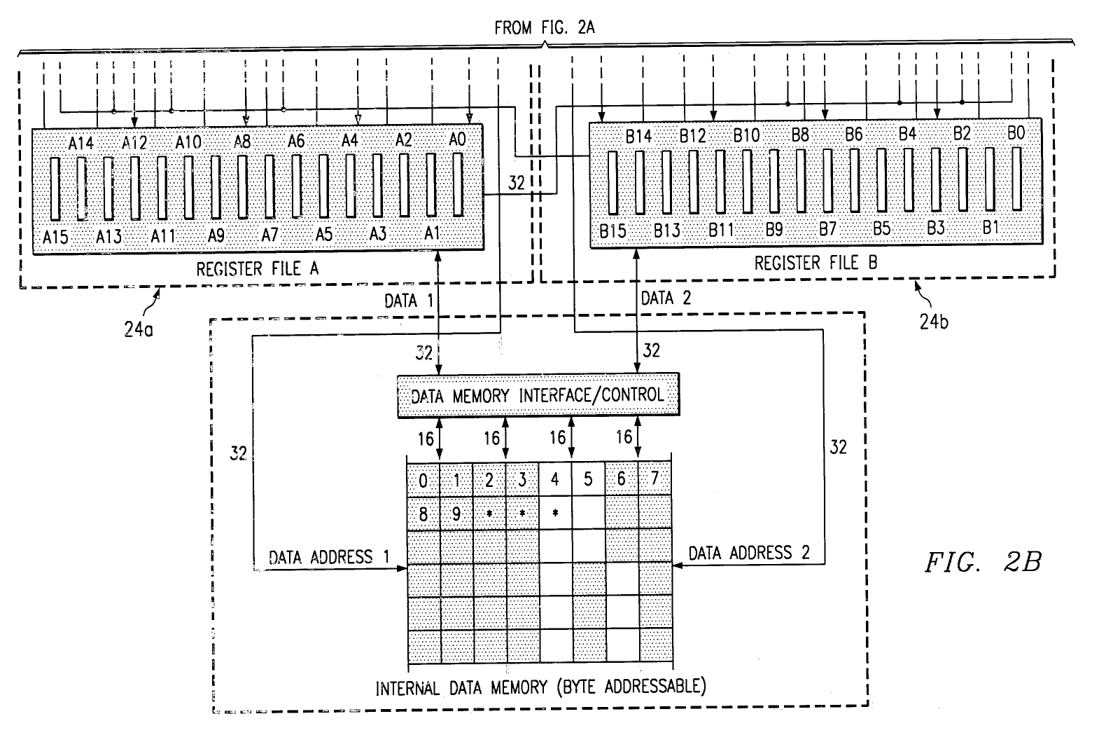

### DESCRIPTION OF THE PREFERRED EMBODIMENT

1. Detailed Description of the Figures

Referring to 7A, the states of a state machine capable of implementing the software loop instruction according to the present invention are shown. In the SLP_IDLE state 701, the loop buffer apparatus is not active. The loop buffer apparatus will leave the SPL_IDLE state when a valid SPLOOP instruction is present in the program register stage. When leaving the SPL_IDLE state 701, the prediction condition, the dynamic length (DYNEN) and the initiation interval (II) are captured. In addition, the prediction condition is evaluated to determine the next state. When the prediction condition is false, the SPL_EARLY_EXIT state 705 is entered. In either situation, the prolog counter and the II counter are reset to zero. For normal operation in response to a SPLOOP instruction, the state machine enters the SPL_PROLOG state 702. In this state, the sequence of instruction stages from the instruction register are executed and stored in a buffer memory unit. In addition, an indicia of the execution unit associated with each instruction stage is stored in a scratchpad memory. After each instruction has been executed at least once and stored in the buffer memory unit, the SPL_PROLOG state 702 transitions to the SPL_KERNEL state 703. In the SPL_KERNEL state 703, the instruction stages in the buffer memory unit are executed simultaneously until the first instruction stage in the sequence has been executed the predetermined number of times. After the execution of the first instruction stage the predetermined times, the state machine enters the SPL_EPILOG state 707. In this state, the buffer memory is drained, i.e., the instruction stages are executed the predetermined number of times before being cleared from the buffer memory unit. At the end of the SPL_EPILOG state 707, the state machine typically transitions to the SPL_IDLE stage 701. However, during the SPL_EPILOG state 707, a new SPLOOP instruction may be entered in the program register. The new SPLOOP instruction causes the state machine to transition to the SPL_OVERLAP state 706. In the SPL_OVERLAP state 706, the instruction stages from the previous SPLOOP instruction continue to be drained from the buffer register unit. However, simultaneously, an SPL_PROLOG state 702 for the new SPLOOP instruction can execute instructions of each instruction stage and enter the instruction stages for the new SPLOOP instruction in the locations of the buffer memory unit from which the instruction stages of the first SPLOOP instruction have been drained. In addition, the state machine has an SPL_EARLY_EXIT state 705 originating from the SPL_PROLOG state 702, the SPL_EARLY_EXIT state 705 transitioning to the SPL_EPILOG state 707 and draining the dispatch buffer register unit 326.

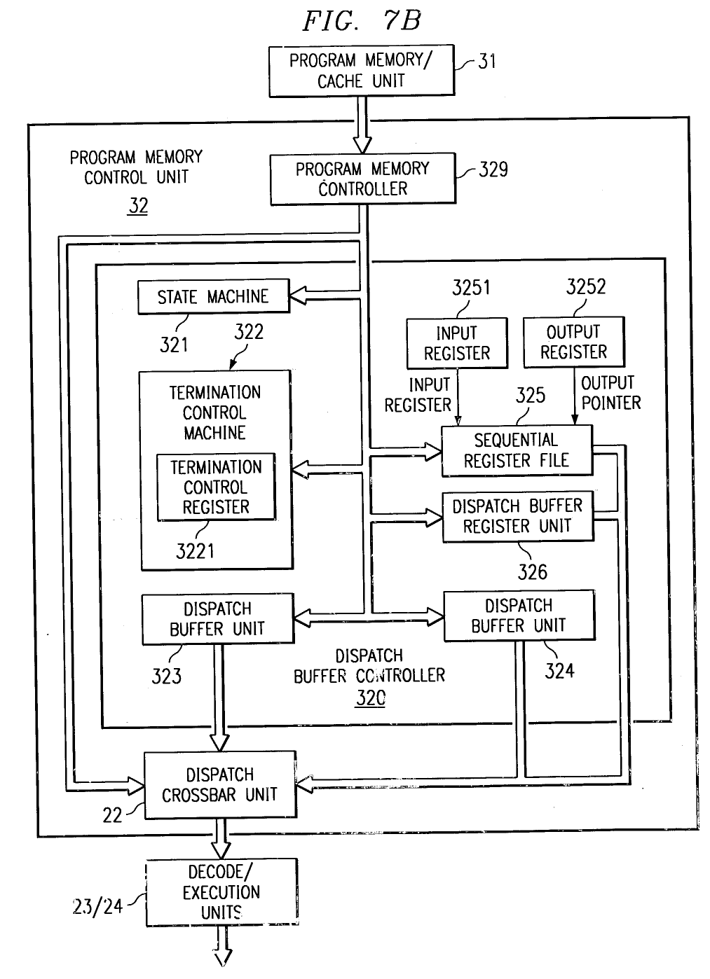

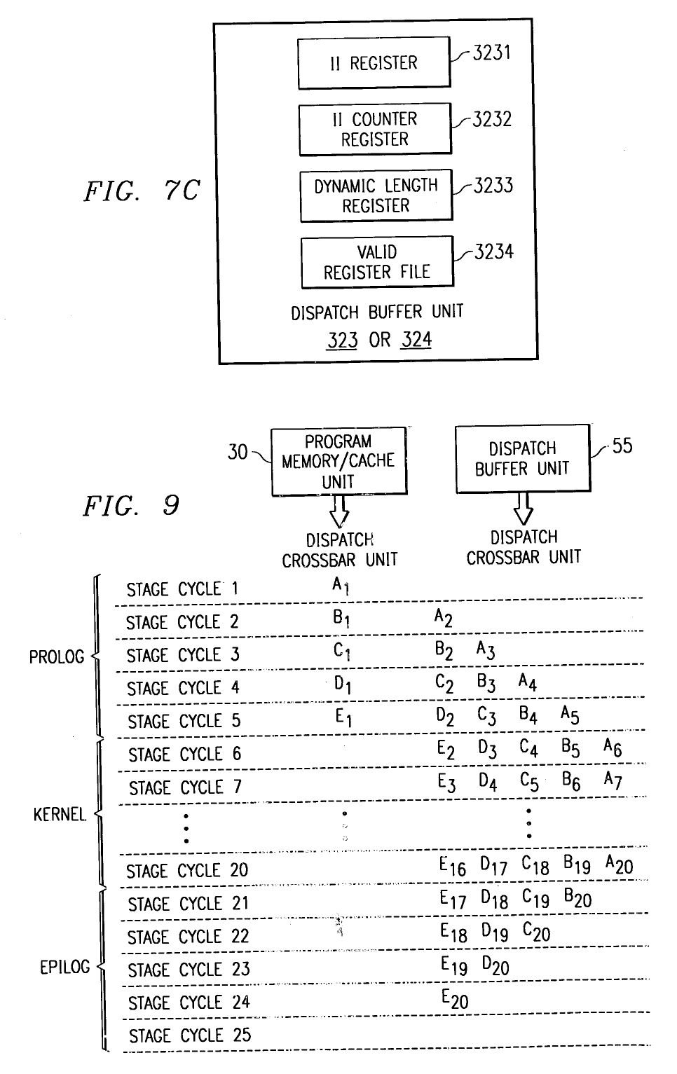

Referring to FIG. 7B, the principal components needed to implement the software pipeline loop operation according to the present invention are illustrated. The program memory controller unit 32 receives instructions from the program memory/cache unit 31. The instructions received from the program memory/cache unit are applied to the program memory controller 329 where the instructions are processed. In particular, the instructions are divided to the execution packet portions and the valid bit portions, i.e., the valid bits determining to which execution unit the associated execute packet portion is directed. From the program memory controller, execution packets and valid bits are applied to the dispatch crossbar unit 22 prior to transmission to the designated decode/execution units 23/24. The execution packets and the valid bits are applied from the program memory controller 329 to the dispatch buffer controller 320. In dispatch buffer controller 320, the valid bits are entered in the sequence register file 325 and in the dispatch buffer units 323/324. The execution packets are entered in the dispatch buffer register unit 326. The SPLOOP instruction is applied to the state machine 321, to the termination control machine 322 and to the dispatch buffer units 323 and 324. Execution packets from the dispatch buffer register unit 326 and valid bits derived from the sequential register file 325 from the dispatch buffer units 323/324 are applied to the dispatch unit for distribution to the appropriate decode/execution units 23/24. The input register 3251 acts as the input pointer and determines the location in the sequential register file into which valid bits are stored. The output register 3252 acts as an output pointer for the sequential register file 325. Both an input pointer and an output pointer are needed because in one state of operation, valid bits are being stored into the sequential register file at the same time that valid bits are being retrieved from the sequential register file. Similarly, two dispatch units 323 and 324 are needed in order to prepare for a following software pipeline loop procedure while finishing a present software pipeline loop procedure.

Referring to FIG. 7C. the principal components of a dispatch buffer unit 323, according to the present invention, are shown. The dispatch buffer units 323 include an II register 3231, an II counter register 3232, a dynamic length register 3233, and a valid register file 3234. The II (initiation interval) parameter is the number of execute packets in each instruction stage. The dynamic length (DyLen) parameter is the total number of execute packets in the software pipeline loop program, i.e., the total number of execute packets that are to be repeated. The dynamic length is included in the SPLOOP instruction that initiates the software pipeline loop procedure. The II parameter is included in the SPLOOP instruction and is stored in the II register 3231. The valid bits stored in the valid register file 3234 identify the decode/execution units 23/24 to which the components of the associated execution packet are targeted. That is, the number of rows in the valid register file 3234 is equal to the II, the number of execution packets in each instruction stage.

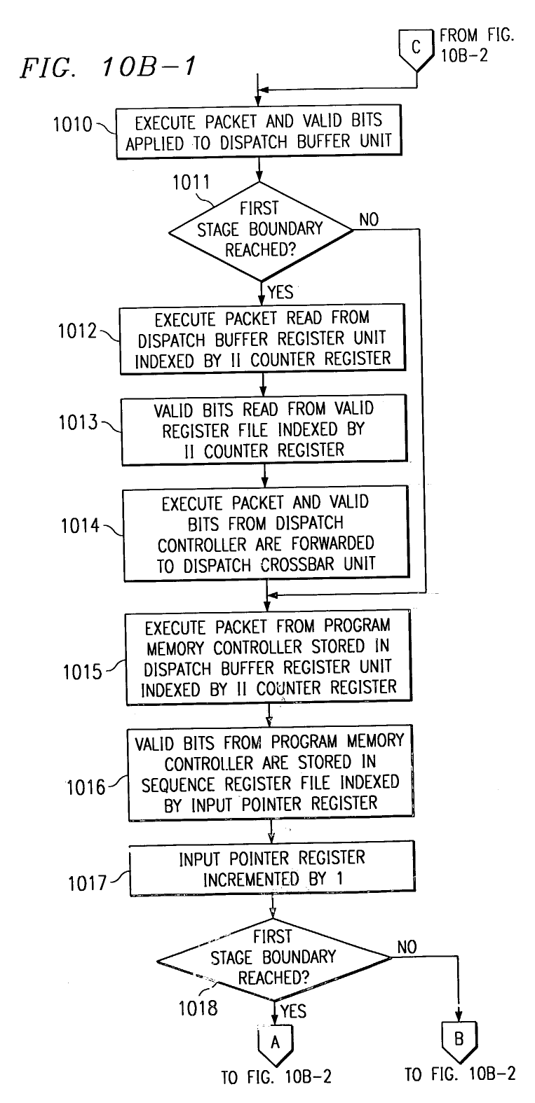

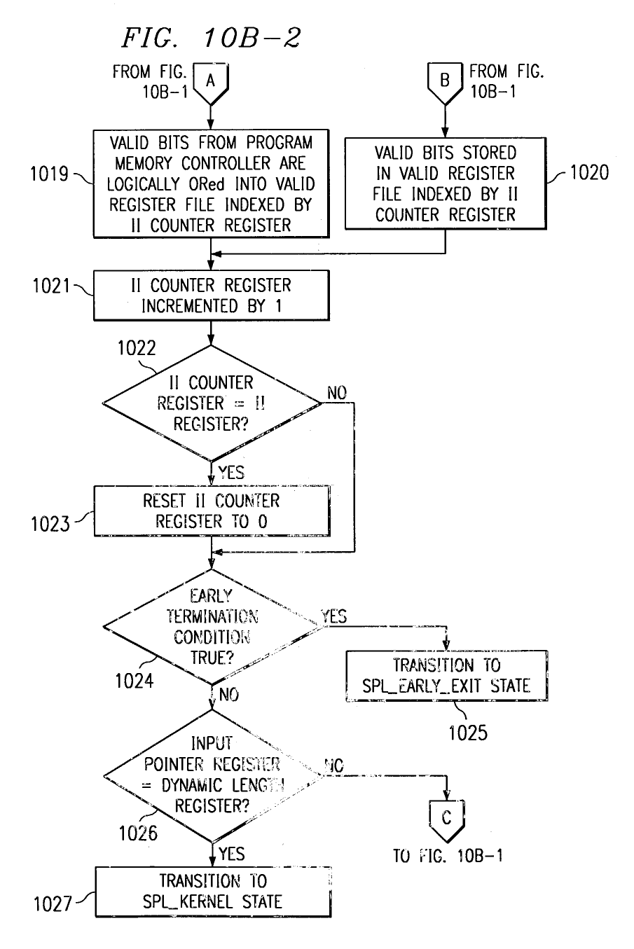

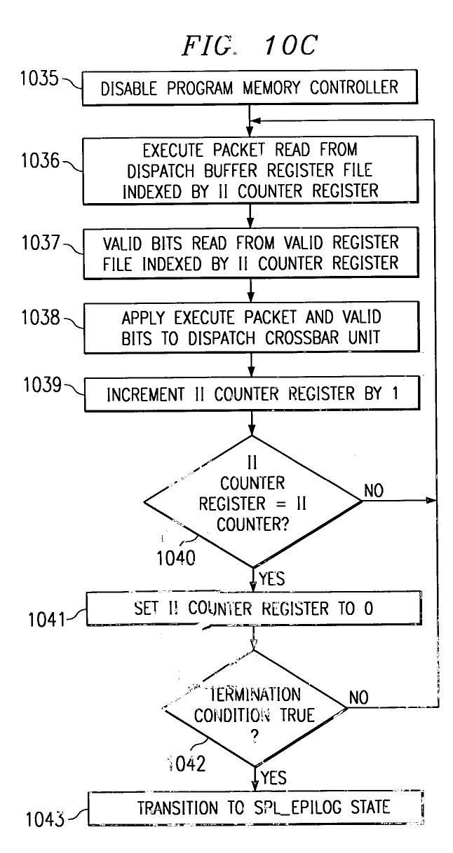

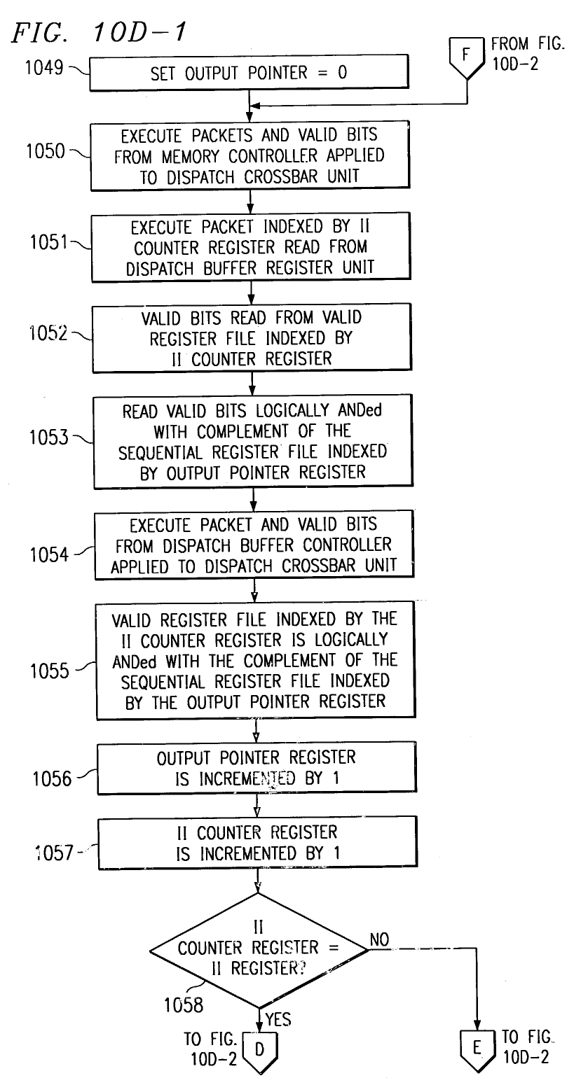

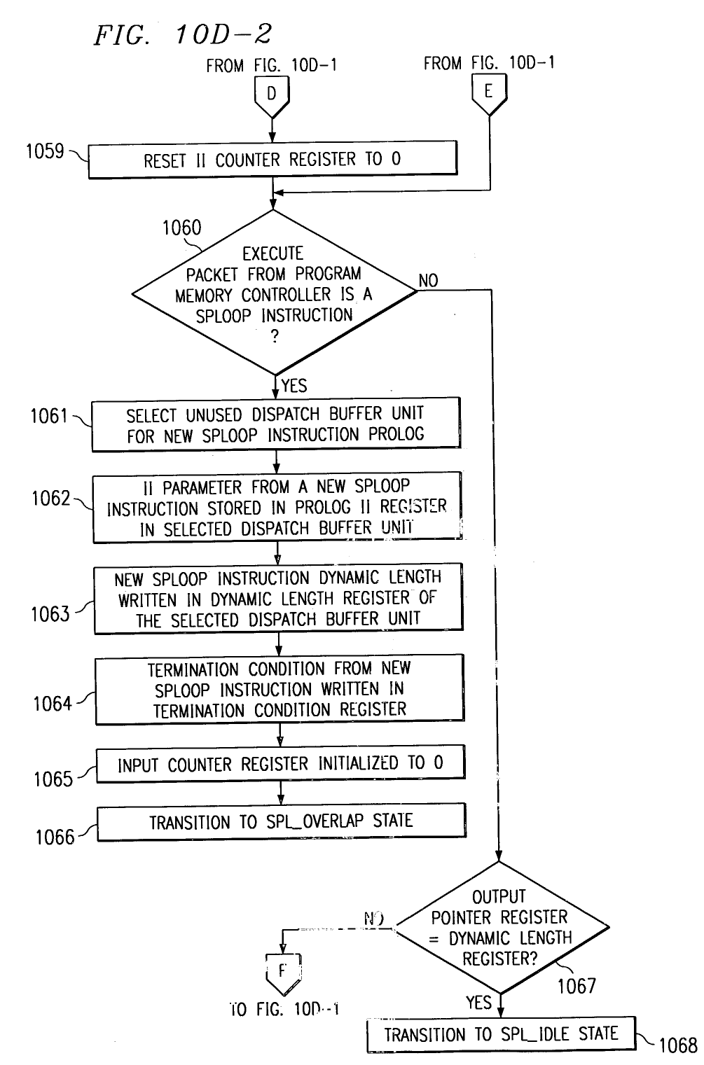

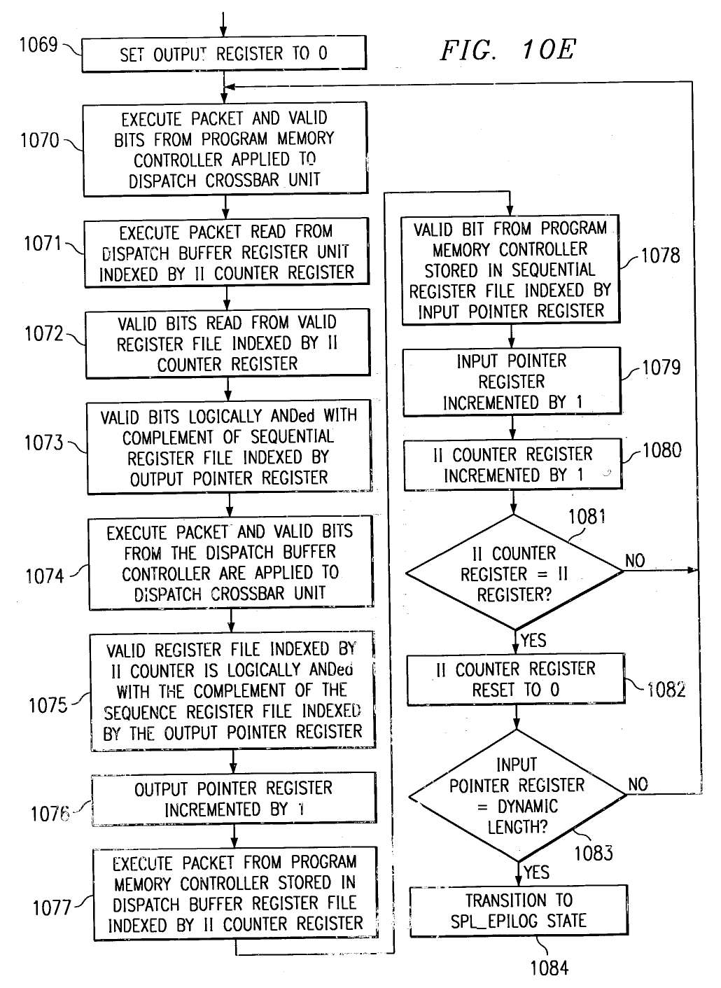

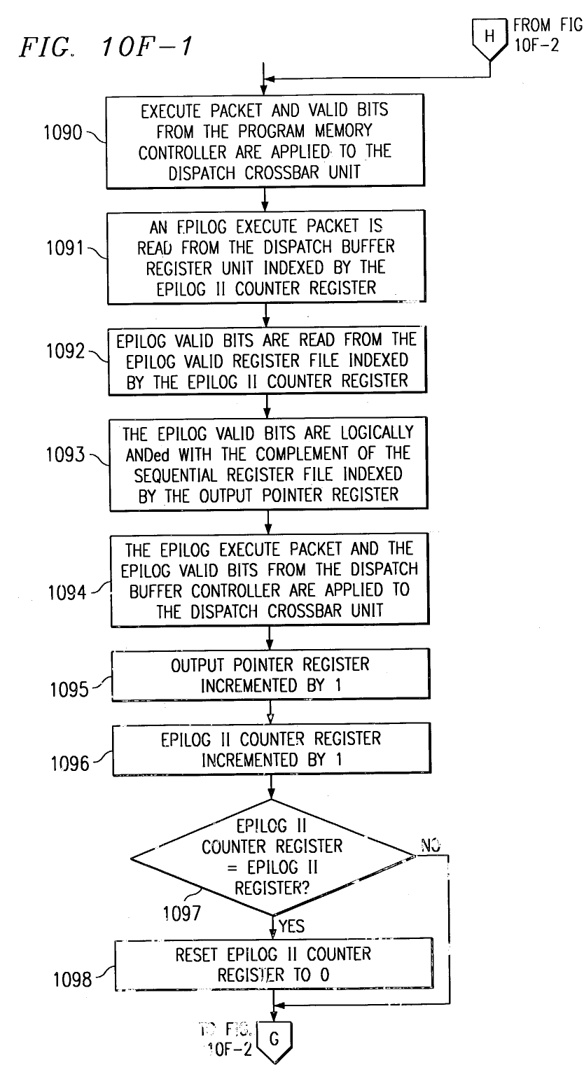

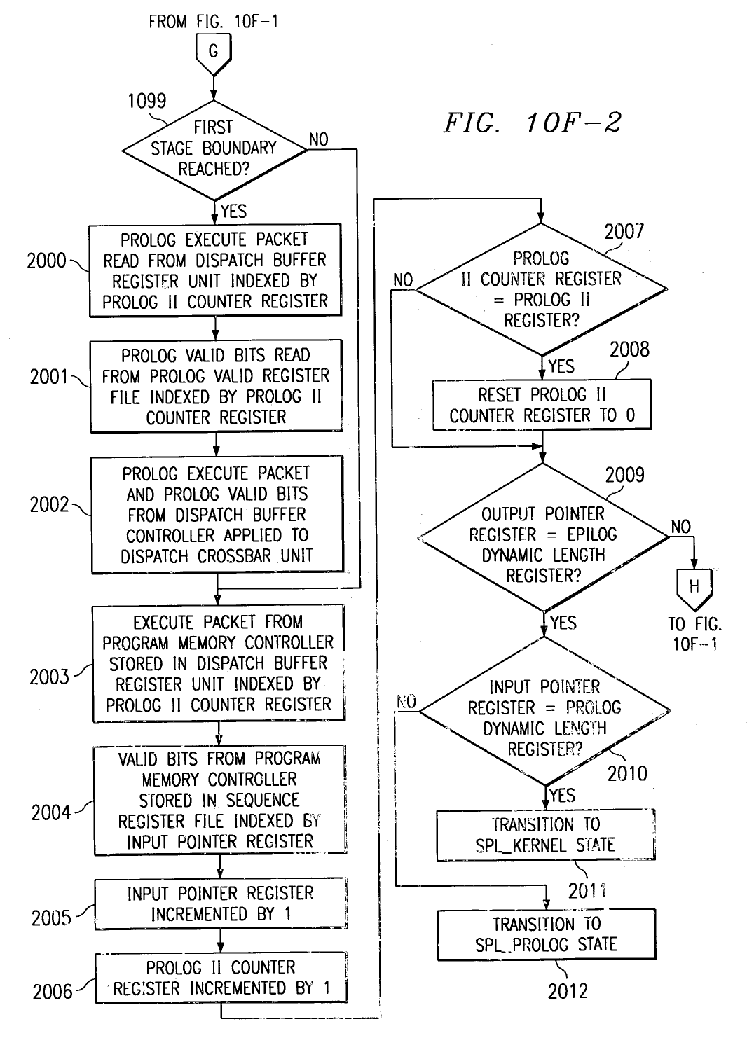

The relationship of the states implementing the software pipeline procedure illustrated in FIG. 7A with the apparatus illustrated in FIG. 7B and FIG. 7C can generally be described as follows. A detailed discussion of the operation of the stages will be given with reference to FIG. 10A through FIG. 10F(2). The dispatch buffer controller 320 in the SPL_IDLE state responds to an SPLOOP instruction, from the program memory controller 329, by initializing the appropriate registers, by entering the II parameters (the number of execution packets in an instruction stage) in the II registers 3231 or 3241; by entering the dynamic length parameter in the dynamic length register 3233 or 3343; and by entering the termination condition in the termination register 3221. The state machine 321 then transitions the dispatch buffer controller 320 to the SPL_PROLOG state. In the SPL_PROLOG state, instructions applied to the program memory controller 329 are separated into execute packets and valid bits, the valid bits determining to which execution unit the individual execute packets will be applied. The execute packets and the valid bits are applied to the dispatch crossbar unit 22 for distribution to the appropriate decode/execution units 23/24. In addition, the execute packets are applied to the dispatch buffer controller 22 and stored in the dispatch buffer register unit 326 at locations determined by an II register counter. Similarly, the valid bits are stored in the sequential register file 325 at a location determined by an input register 3251 and are stored in a valid register file 3234 at a location indicated by the II counter register 3232. The input register 3251 and the II counter register 3232 are incremented by 1 and the process is repeated. When the II counter register 3232 reaches a value determined by the II parameter stored in the II register 3231, the II counter register 3231 is reset to zero. The II register 3231 identifies the boundaries of the instruction stages. The procedure continues until the input register 3251 is equal to the value in the dynamic length register 3233. At this point the state machine transitions the apparatus to the SPL_KERNEL state. In the SPL_KERNEL state, the program memory controller is prevented from applying execute packets and valid bits to the dispatch buffer controller 320. The execute packets stored in the dispatch buffer unit 22 and the associated valid bits stored in the valid register file 3234, each at locations indexed by the II counter register 3232, are applied to the dispatch crossbar unit 22. The II counter register 3232 is incremented by 1 after each application of the execute packets and associated valid bits to the dispatch crossbar unit 22. When the count in the II counter register 3232 is equal to the II parameter in the II register 3231, the II counter register 3232 is reset to zero. The process continues until the termination condition identified by the termination condition register 3221 is identified. Upon identification of the termination condition, the state machine transitions the dispatch buffer controller 320 to the SPL_EPILOG state. In the SPL_EPILOG state, execute packets are retrieved from the dispatch buffer register unit 326 at locations determined by the II counter register 3232. Valid bits are retrieved from the valid register file 3234 also at locations identified by the II counter register 3232 and applied to the dispatch crossbar unit 22. The valid bits in the sequential register file 325 are retrieved and combined with the valid bits in the valid register file 3234 in such a manner that, in future retrievals from the dispatch buffer register 326, the execution packets associated with the valid bits retrieved from the sequential register file 325 are thereafter masked from being applied dispatch crossbar unit 22. The II counter register 3232 is incremented by 1, modulo II, after each execution packet retrieval. The output register 3252 is incremented by 1 after each execution packet retrieval. The procedure continues until the output register 3252 equals the parameter in the dynamic length register. When this condition occurs, the state machine transitions the SPL_IDLE state. When the termination condition is triggered during the SPL_PROLOG state, the state machine causes the dispatch buffer controller 320 to enter the SPL_EARLY_EXIT state. In the SPL_EARLY_EXIT state, the output register begins incrementing even as the input register is still incrementing. In this manner, all execution packets are entered in the dispatch buffer register unit 326. However, the dispatch buffer controller 320 has already started masking execution packets stored in the dispatch buffer register unit 326 (i.e., upon identification of the termination condition) in the manner described with respect to the SPL_EPILOG state. The procedure will continue until the contents of the output register 3252 are equal to the contents of the dynamic length register 3233. An SPL_OVERLAP state is entered when a new SPLOOP instruction is identified before the completion of the SPL_EPILOG state. A second dispatch buffer unit 324 is selected to store the parameters associated with the new SPLOOP instruction. The other dispatch buffer unit 323 continues to control the execution of the original SPLOOP instruction until the original SPLOOP instruction execution has been completed.

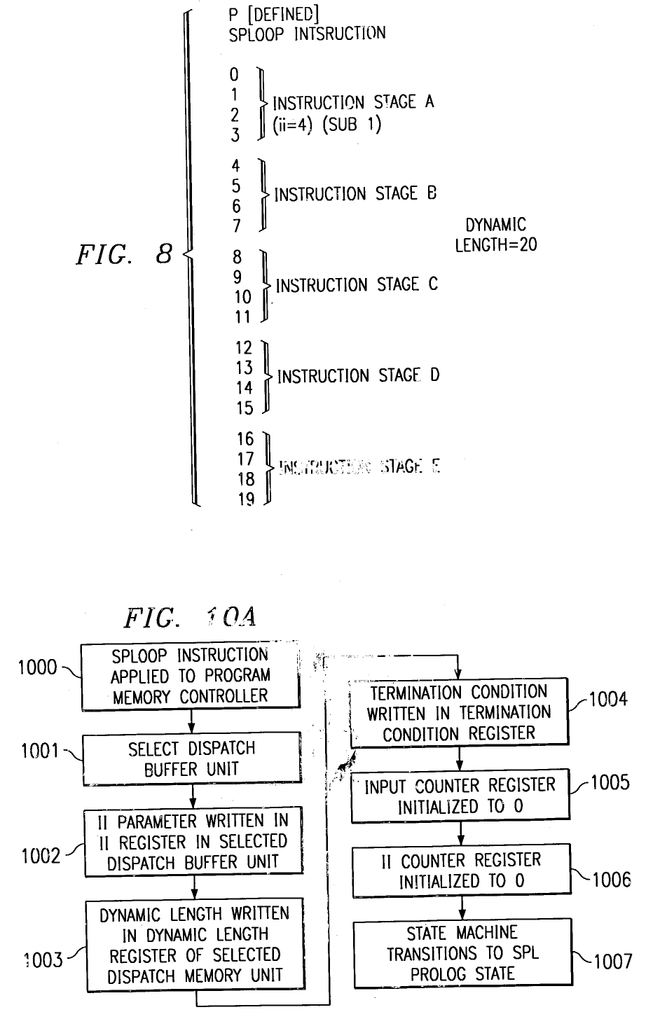

Referring to FIG. 8. an example of the structure of the instruction group that can advantageously use the present invention is shown. A value is defined in the termination control register 3221. This value determines the number of times that a group of instructions is to be repeated. The instruction set then includes a SPLOOP instruction. The SPLOOP instruction includes the parameter II and the parameter Dylen (dynamic length). The II parameter is the number of instructions, including NOP instructions that are found in each instruction stage. In the example shown in FIG. 8, instructions stages A, B, C, D, and E are shown. Each instruction stage includes four instructions, i.e., II=4 and the DYLEN=20. Furthermore, the instruction set includes a SUB 1 (subtract 1) instruction which operates on the termination control register 3231. In this manner, when the termination control register 3231 is 0 (P=0), the correct number of repetitions has been performed on at least one instruction stage.

Referring to FIG. 9, the origin of instruction stages from the apparatus shown in FIG. 7B for an instruction group repeated 20 times is illustrated. During stage cycle 1, instruction stage A₁ is applied by the program memory controller unit 30 to the dispatch crossbar unit 22 and to the dispatch buffer unit 55. (Note that an instruction stage can include more than one instruction and an instruction stage cycle will include clock cycles equal to the number of instruction stages.) During instruction stage cycle 2, the instruction stage B₁ is applied to the dispatch crossbar unit and to the dispatch buffer unit 55. Also during instruction cycle 2, the instruction stage A₂ is applied to the dispatch interface unit 22 from the dispatch buffer unit 55. In instruction cycles 3 through 5, successive instruction stages in the sequence are applied to the dispatch crossbar unit 22 and to the dispatch buffer unit 55. The previously stored instruction stages in the dispatch buffer unit 55 are simultaneously applied to the dispatch crossbar unit 22. At the end of instruction cycle 5, all of the instruction stages A through E are stored in the dispatch buffer unit 55. The SPLOOP prologue is now complete. From cycle 6 until the completion of the SPLOOP instruction at cycle 24, all of the stages applied to the dispatch crossbar unit 22 are from the dispatch buffer unit 55. In addition, instruction stages A₁ through E₁ have been applied to the dispatch crossbar unit 22 by cycle 5 and, consequently, to the decode/execution unit 23/24. Therefore, after a latency period determined by the hardware pipeline, the result quantity R₁(A₁, . . . ,E₁) of the first iteration of the software pipeline is available. The cycles during which all instruction stages are applied from the dispatch buffer unit 55 to the dispatch crossbar unit 22 are referred to as the kernel of the SPLOOP instruction execution. At cycle 20, the A₂₀ stage is applied to the dispatch crossbar unit 22. Because of the number of iterations for the instruction group is 20, this is the final time that instruction stage A is processed. In instruction stage cycle 21, all of the instruction stages except stage A (i.e., instruction stages B₂₀, C₁₉, D₁₈, E₁₇) are applied to the dispatch crossbar unit 22. During each subsequent cycle, one less stage is applied form the dispatch buffer unit 55 to the dispatch crossbar unit 22. This period of diminishing number of stages being applied from the dispatch buffer unit 55 to the dispatch crossbar unit 22 constitutes the epilog state. When the E₂₀ stage is applied to the dispatch crossbar unit 22 and processed by the decode/execution unit 23/24, the execution of the SPLOOP instruction is complete.

Referring to FIG. 10A, the response of the program memory control unit 32 in an SPL_IDLE state to an SPLOOP instruction is illustrated. In step 1000, an SPLOOP instruction is retrieved from the program memory cache unit 31 applied to the program memory controller 329. In response to the SPLOOP instruction, a (non-busy) dispatch memory unit 323/324 is selected. The SPLOOP instruction includes an II parameter, a dynamic length parameter and a termination condition. In step 1002, the II parameter is stored in the II register 3231 of the selected buffer, the dynamic length parameter is stored in the dynamic length register 3233 of the selected buffer unit in step 1003, and the termination condition is stored in the termination control register 3221 of the termination control machine 322 in step 1004. The input register 3251 associated with the input pointer of the sequence register file 325 is initialized to 0 in step 1005. In step 1006, the II counter register 3232 is initialized to 0. In step 1007, the state machine transitions to the SPL_PROLOG state.

Referring to FIG. 10B(1) and FIG. 10B(2), the response of the program memory control unit 32 in the SPL_PROLOG state to the SPLOOP instruction is shown. In step 1010, the execute packets and the valid bits from the program memory controller 329 are applied to the dispatch crossbar unit 22. In step 1011, a determination is made whether the first stage boundary has been reached. When the determination in step 1011 is positive, then in step 1012 an execute packet is read from the dispatch buffer register unit 326 at location indexed by the II counter register 3232. Valid bits are read from the valid register file 3234 at locations indexed by the II counter register 3232 in step 1013. In step 1014, the execute packet and the valid bits from the dispatch buffer controller 320 are applied to the dispatch crossbar unit 22. When the first stage boundary has not been reached in step 1011 or continuing from step 1014, in step 1015 the execute packet from the program memory controller 329 is stored in the dispatch buffer register unit 326 at locations indexed by the II counter register 3232. In step 1016, the valid bits from the program memory controller 320 are stored in the sequence register file 325 at locations indexed by the input pointer register 3251. In step 1017, the input pointer register 3251 is incremented by 1. In step 1018, a determination is made whether the procedure has reached the first stage boundary. When the first stage boundary has been reached in step 1018, then valid bits from the program memory controller 329 are logically ORed into the valid register file 3234 at locations indexed by the II counter register 3232 in step 1019. When the first stage boundary has not been reached in step 1018, then the valid bits are stored in the valid register file 3234 at locations indexed by the II counter register 3232, Step 1019 or step 1020 proceed to step 1021 wherein the II counter register 3232 is incremented by 1. In step 1022, a determination is made whether the contents of the II counter register 3232 is equal to the contents of the II register 3231. When the contents of the two registers are equal, then the II counter register 3232 is reset to zero in step 1023. When the contents of the registers in step 1022 are not equal or following step 1023, a determination is made whether the early termination condition is true in step 1024. When the early termination condition is true, the procedure transitions to the SPL_EARLY_EXIT state. When the early termination condition is not true in step 1024, then a determination is made whether the contents of the input pointer register 3251 are equal to the contents of the dynamic length register 3233 in step 1026. When the contents of the two registers are equal, the in step 1027 the procedure transitions to the SPL_KERNEL state. When the contents of the two registers are not equal in step 1026, the procedure returns to step 1010.

Referring to FIG. 10C, the response of the SPL_KERNEL state to the SPLOOP instruction is shown. In step 1035, the program memory controller 329 is disabled to insure that all the instruction being executed are from the dispatch buffer register unit 326. In step 1036, the execute packet at the locations indexed by the II counter register 3232 are read from the dispatch buffer register unit 326, while in step 1037, the valid bits at locations indexed by the II counter register 3232 in the valid register file 3234 are also read. The execute packet from the dispatch buffer register unit 326 and the valid bits from the valid register file 3234 are applied to the dispatch crossbar unit 22 in step 1038. In step 1039, the II counter register 3232 is incremented by 1. In step 1040, a determination is made if the II counter register 3232 is equal to the II register 3231. When the determination is negative, the procedure returns to step 1036. When the determination is positive, the II counter register 3232 is set equal to 0 in step 1041. In step 1042, a determination is made whether the termination condition is present. When the termination condition is not present, the procedure returns to step 1036. When the termination condition is present, the program memory control unit 32 transitions to the SPL_EPILOG state in step 1043 Referring to FIG. 10D(1) and FIG. 10D(2), the response of program memory control unit 32 to an SPLOOP instruction and SPL_EPILOG state is shown. The output point is set equal to 0 in step 1049. In step 1050, execute packets and valid bits from the program memory controller 329 are applied to the dispatch crossbar unit 22. In step 1051, an execute packet from locations indexed by the II counter register 3232 are read from the dispatch buffer register unit 326. Valid bits are read from the valid register file 3234 at locations indexed by the II counter register 3232 in step 1052. In step 1053, the read valid bits are logically ANDed with the complement of the sequence register file 325 indexed by the output pointer register 3252. The execute packets and the valid bits from the dispatch buffer controller 320 are applied to the dispatch crossbar unit 22 in step 1054. In step 1055, the valid register file locations indexed by the II counter register 3234 are logically ANDed with complement of the sequence register file indexed by the output pointer register 3252. In step 1056, the output pointer register 3252 is incremented by 1. The II counter register 3232 is incremented by 1 in step 1057. In step 1058, a determination is made whether the contents of the II counter register 3232 equal the contents of the II register 3231. When the two contents are not equal, then the procedure returns to step 1050. When the quantities in step 1058 are equal, then in step 1059, the II counter register 3232 is reset to 0. When the contents are equal in step 1058 or following from step 1059, a determination is whether the execute packet from the program memory controller 329 is a SPLOOP instruction in step 1060. When the execute packet is SPLOOP instruction, the unused dispatch buffer unit 324 is selected for the parameters of the new SPLOOP instruction in step 1061. In step 1062, the II parameter from the new SPLOOP instruction is stored in the prolog II register 3231 in the selected dispatch buffer unit 324. The dynamic length from the new SPLOOP instruction is stored in the prolog dynamic length register 3233 of the selected dispatch buffer unit 324 in step 1063. In step 1064, the termination condition from the new SPLOOP instruction is written in the termination condition register 3221. The input counter register 3251 is initialized to 0 in step 1065 and the transition is made to the SPL_OVERLAP state in step 1066. The execute packet in step 1060 is not an SPLOOP instruction in step 1060, then in step 1067, a determination is made whether the contents of the output pointer register 3252 are equal to the contents of the (epilog) dynamic length register 3233. When the contents of the registers are not equal, then the procedure returns to step 1050. When the contents of the two registers are equal, the process transitions to SPL_IDLE state.

Referring to FIG. 10E, the response of the program memory control unit 32 in the SPL_EARLY_EXIT state to a SPLOOP instruction is show. In step 1069, the output pointer register 3252 is set equal to 0. In step 1070, an execute packet and valid bits from the program memory controller 329 are applied to the dispatch crossbar unit 22. An execute packet is read from the dispatch buffer register unit 326 at locations indexed by the contents of the II counter register 3232 in step 1071. In step 1072, valid bits are read from the valid register file 3234 indexed by the II counter register 3232. In step 1073, the valid bits are logically ANDed the complement of the locations of the sequence register file 325 indexed by the output pointer register 3252. The execute packet and the combined valid bits from the dispatch buffer controller 320 are applied to the dispatch crossbar unit 22 in step 1074. In step 1075, the contents of the valid register file 3234 indexed by the II counter register 3232 are logically ANDed with the complement of the sequence register file location indexed by the output pointer register 3252. The output pointer register 3252 is incremented by 1 in step 1076. In step 1077, the execute packet from the program memory controller 329 is stored in the dispatch buffer register unit 326 at locations indexed by the II counter register 3232. In step 1078, the valid bits from the program memory controller 329 are stored in the sequence register file 325 at locations indexed by the input pointer register 3251. In step 1079, the input pointer register 3252 is incremented by 1, and in step 1080, the II counter register 3232 is incremented by 1. In step 1081, a determination is made whether the contents of the II counter register 3232 are equal to the contents of the II register 3231. When the contents of the two registers are not equal, the procedure returns to step 1070. When the contents of the registers are equal, the II counter register 3232 is reset to 0. A determination is then made whether the contents of the input pointer register 3252 are equal to the contents of the dynamic length register 3233. When the contents of the two registers are not equal, the procedure returns to step 1070. When the contents of the two registers are equal, the program memory control unit transitions 32 to the SPL_EPILOG state.

Referring to FIG. 10F(1) and FIG. 10F(2), the response of the program memory control unit 32 in the SPL_OVERLAP state to a SPLOOP instruction is illustrated. In this state, one of the dispatch buffer units 323 is in use with the SPLOOP instruction that is in the epilog state. For the prolog portion of the new SPLOOP instruction, the second dispatch buffer unit 324 will simultaneously be in use in the SPL_OVERLAP state. In step 1090, an execute packet and valid bits from the program memory controller 329 are applied to the dispatch crossbar unit 22. An epilog execute packet is read from the dispatch buffer register unit 326 from location indexed by the epilog II counter register 3232 in step 1091. In step 1092, epilog valid bits are read from the epilog valid register file 3234 at locations indexed by the epilog II counter register 3232. The epilog valid bits are logically ANDed with the complement of the sequential register file 325 at locations indexed by the output pointer register 3252 in step 1093. In step 1094, the epilog execute packet and the combined valid bits from the dispatch buffer controller 320 are applied to the dispatch buffer unit 22. The output pointer register 3252 is incremented by 1 in step 1095 and the epilog II counter register 3232 is incremented by II in step 1096. In step 1092, a determination is made whether the contents of the epilog II counter register 3232 are equal to the contents of the epilog II register 3231. When the contents are equal, the epilog II counter register 3232 is set to 0 in step 1098. When the contents of the registers are not equal in step 1092, the procedure advances to step 1098 wherein a determination is made whether the first stage boundary has been reached. When the first stage boundary has been reached, a prolog execute packet is read from the dispatch buffer register unit 326 at locations indexed by the prolog II counter register 3232 in step 2000. In step 2001, prolog valid bits are read from the prolog valid register file 3234 at locations indexed by the prolog II counter register 3232. The prolog execute packet and the prolog valid bits from the dispatch buffer controller e320 are applied to the dispatch crossbar unit 22 in step 2002. When the first stage boundary has not been reached or continuing from step 2002, in step 2003, the execute packet from the program memory controller 329 is stored in the dispatch buffer register unit at locations indexed by the prolog counter register. In step 2004, valid bits from the program memory controller 329 are stored in the sequence register file 325 at location indexed by the input pointer register 3251. The input pointer register 3251 is incremented by 1 in step 2006 and the prolog II counter register 3232 is incremented by 1 in step 2005. In step 2007, a determination is made whether the contents of the prolog II counter register 3232 are equal to the contents of the prolog II register 3231. When the contents of the two registers are equal, in step 2008, the prolog II counter register 3232 is reset to 0. When the contents of the registers are not equal of after step 2008, in step 2009, a determination is made whether the contents of the output pointer register 3252 is equal to the contents of the epilog dynamic length register 3233. When the contents of the registers are not equal, the procedure returns to step 1090. When the contents of the registers are equal, a determination is made in step 2010 whether the contents of the input pointer register 3251 is equal to the contents of the prolog dynamic length register 3233. When the contents of the registers are equal, then the procedure transitions to the SPL_KERNEL state. When the contents of the registers are not equal in step 2010, the procedure transitions to the SPL_PROLOG state.

Referring to FIG. 11A, an example of a software pipeline procedure for five instructions repeated N times is shown. During the SPL_PROLOG state, the dispatch buffer unit is filled. During the SPL_KERNAL state, the instruction stages in the dispatch buffer unit are repeatedly applied to the dispatch crossbar unit until the first instruction stage A has been repeated N times. When the first instruction stage A has been executed N times, the predetermined condition is satisfied and the SPL_EPILOG state is entered. In the SPL_EPILOG state, the dispatch buffer is gradually drained as each instruction stage is executed N times. The procedure in FIG. 11A is to be compared to FIG. 11B wherein the condition is satisfied before the end of the SPL_PROLOG state. Once the condition is satisfied in the SPL_PROLOG state, then the program memory controller enters the SPL_EARLY_EXIT state. In this state, the instruction stages remaining in the program memory/cache unit continue to be entered in the dispatch buffer unit, i.e., the input pointer continues to incremented until the final location of the scratch pad register is reached. However, after the application of each instruction stage to the dispatch crossbar unit, the output pointer is also incremented resulting in the earliest stored instruction stage being drained from the dispatch buffer unit. This simultaneous storage in and removal from the dispatch buffer unit is shown in the portion of the diagram designated as the early exit.

Referring to FIG. 12A, a nested-loop sequence of software instructions is illustrated. The sequence of instructions is an outer loop of instructions O(1) through O(w). This sequence of instructions is to be executed a first predetermined number of times. However, each time the sequence of outer loop instructions O(1) through O(w) reaches instruction O(m), an inner loop sequence of instructions I(1) through I(q) is executed a second predetermined number of times that can be determined by the outer loop instructions. The inner loop will typically be preceded by an SPLOOP instruction. When the inner loop software pipeline procedure is complete, the outer loop sequence of instructions continues with the sequence O(n) through O(w). If the first predetermined number has not been reached, then the program execution returns to instruction O(1) and the process is repeated until the first predetermined number is reached. Referring to FIG. 12B, the process for implementing the execution of the nested-loops is illustrated. In step 121, a parameter T is set equal to 1. The instructions O(1) through O(m) are executed in step 122. In step 123, a parameter S is set equal to 1. Instructions I(1) through I(q) are executed in step 124. In step 125, the parameter S is incremented. In step 126, the parameter S is then compared to 100, i.e., the second predetermined value has been set equal to 100 in this example. When the parameter S is not equal to 100, then the process returns to step 124. When the parameter is equal to 100, then the process proceeds to step 127 wherein instructions O(n) through O(w) are executed. In step 128, the parameter T is incremented by 1. In step 129, a test is made to determine whether T is equal to 100, i.e., 100 is the first predetermined value. When the comparison is false in step 129, then the process returns to step 122. When the comparison is true, the process continues to the next instruction.

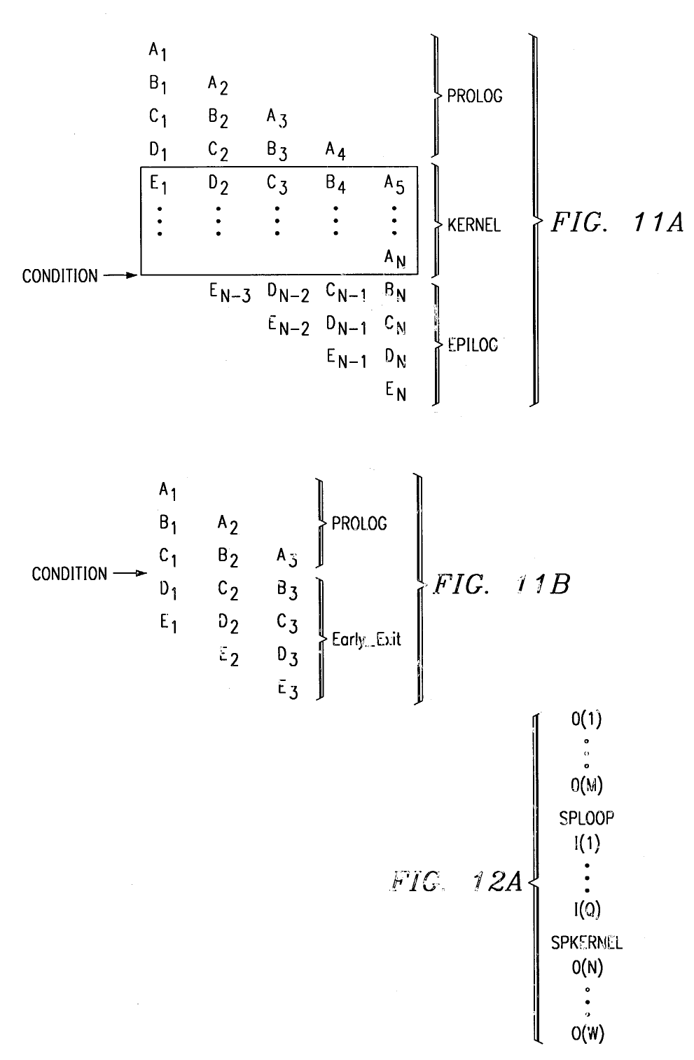

Referring to FIG. 13, the use of a software pipeline process to improve the efficiency of the execution of a nested-loop program is shown. In step 131. the first parameter is set equal to 1. In step 132, the instructions O(1) through O(m) are executed. At some point during or after the execution of the instructions O(1) through O(m), the software pipeline procedure is implemented in step 133. The SPLOOP instruction is encountered and the software pipeline procedure enters the SPL_PROLOG state and the buffer memory unit is filled. After the SPL_KERNEL state, begins the SPL_EPILOG state is entered. In step 134, the O(N) through O(W) instructions are executed. As will be clear, the SPL_EPILOG state can be used to provide an overlap of the execution of the epilog instructions and the execution of the O(N) through O(W) instructions. In step 135, the parameter T is incremented by 1. In step 136, a determination is made whether the parameter T is equal to the 100 (i.e., the predetermined first value). When T is not equal to 100 in step 136, the process returns to step 132. When T is equal to 100, the nested-loop program is complete and the next instruction in the program memory is retrieved.

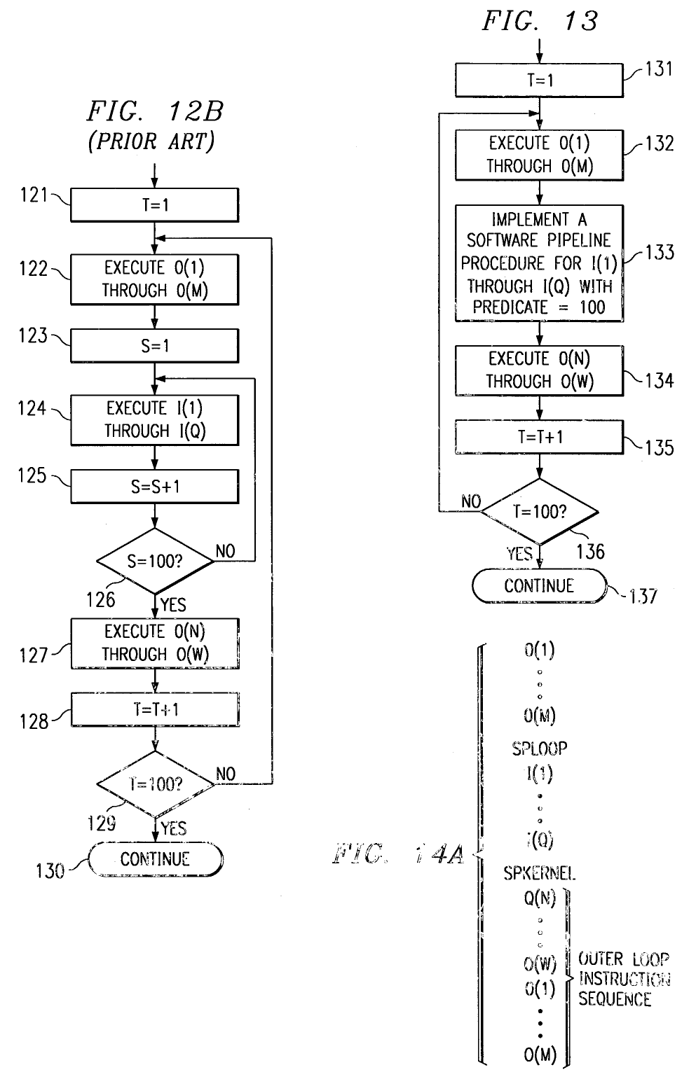

Referring to FIG. 14A, an arrangement for improved execution of the outer loop nested instructions is shown. In this embodiment, the outer loop instruction sequence is stored in the program memory/cache buffer unit 31 in a sequence starting with the group of instructions immediately following the inner loop instructions {O(N) through O(W)} followed by the outer loop instruction sequence preceding the inner loop instruction sequence {O(1) through O(M)}. The outer loop instruction sequence, {O(N)-O(W); O(1)-O(M)}, is stored in the program memory/cache unit in sequential locations. The advantage of this arrangement is that once an execution of the inner loop is completed, the program counter, which can be reset for example by a branch instruction executing in the outer loop procedure, can cycle through the outer loop program in sequence. At the end of the outer loop instruction sequence, the inner loop instruction sequence can be initiated. While in the preferred embodiment, the outer loop instruction sequence, {O(N)-O(W); O(1)-O(M)}, is stored in the program memory cache unit 31. The delay of the retrieval of instructions from the program memory/cache unit 31 can be eliminated by storing the outer loop instruction sequence in a buffer storage unit (not shown) in the program memory control unit 32.

However, the execution of nested loop instruction sequence can be improved further. For many of the nested loop programs, the outer loop instructions are relatively few and relatively simple, e.g., the outer loop can include instructions for moving values between registers. Referring to FIG. 14B, the nested loop procedure can be further expedited by providing for an overlap between the qth inner loop epilog procedure and outer loop procedure and between the outer loop procedure and the (q+1)th inner loop prolog procedure. The last execution packet of the inner loop software program includes an SPKERNEL instruction. The SPKERNEL instruction, as discussed elsewhere, results in the transition to the SPL_KERNEL state. As also discussed, the SPKERNEL instruction includes a parameter that defines the delay before the program counter begins accessing the outer loop instruction sequence. The SPKERNEL instruction therefore replaces NOP instruction that would otherwise have to be inserted in the outer loop instruction sequenced. In addition, the SPKERNEL instruction includes a parameter that determines the delay before the next inner loop procedure is begun. Consequently, as illustrated in FIG. 14, the inner loop epilog 142, outer loop execution 143 and the next inner loop prolog 144 can all be in execution simultaneously. The use of the second parameter of the SPKERNEL instruction causes the activity that results in a more efficient execution of the nested loop procedure. This efficiency results from the fact that the contents of the sequential register file 325 and the sequential register file 326 are reused. Because these quantities are not retrieved from the program memory/cache unit 31 for each SP_PROLOG state, the inner nested loop execution can be enhanced. The input pointer of the sequential register file is used to retrieve the valid bits stored in the location identified by the in the input pointer. The valid bits retrieved from the sequential register file 325 are entered in the valid bit register 3234 and control the application of the execution packets to the dispatch crossbar unit 22. The result is that application of execution packets to the dispatch buffer unit replicates the inner loop prolog procedure. A branch instruction in the outer loop procedure 143 can be used to reset the program counter at the end of the execution of the outer loop instruction sequence. (The fetching of outer loop instructions is disabled after the program counter is reset until the end of the inner loop kernel procedure 145.)

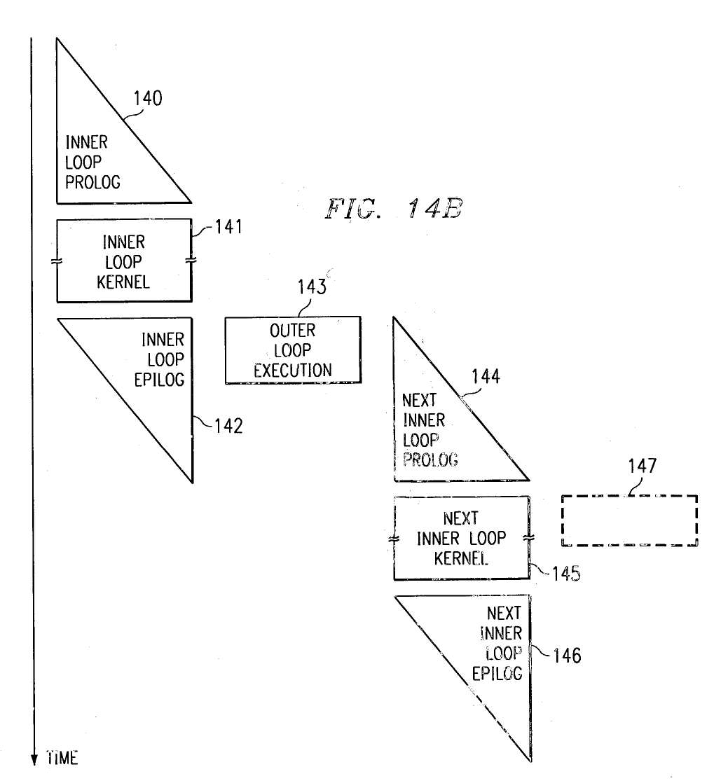

Referring to FIG. 15, the problem of the conflict between instructions in the inner loop prolog execution packets and instructions in the outer loop execution packets is illustrated. As inner loop epilog 142 and the outer loop program 143 are being executed, during clock tₙ an execution packet from the dispatch buffer register unit 326 and an execution packet from outer loop program 143 are applied to the dispatch crossbar unit 22 simultaneously. Instruction 1421 in the inner loop epilog execution packet and instruction 1431 in the outer loop instruction packet are to be executed on the same decode/execution unit.

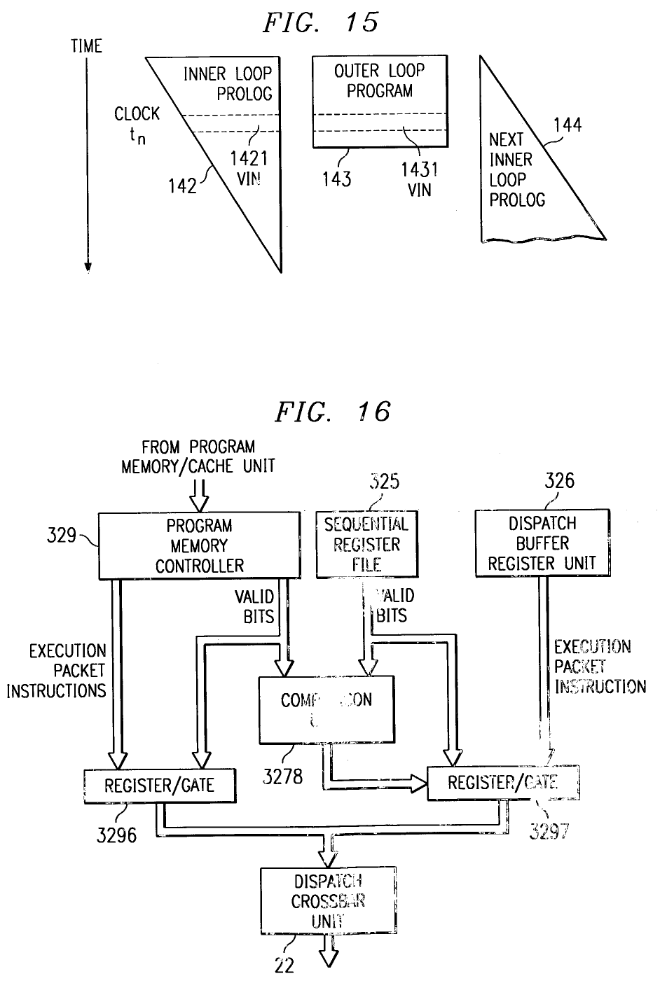

Referring to FIG. 16, the technique for avoiding the instruction conflict, illustrated in FIG. 15, is shown. During the overlapping execution of the inner loop and outer loop instructions, the instructions and valid bits for the outer loop execution packet from the program memory controller 329 is applied to register/gate 3276, while the instructions and valid bits from the dispatch buffer register unit 326 and the sequential register file 325, respectively, are applied to register/gate 3277. The valid bits from the program memory controller 329 and the sequential register file 325 are applied to comparison unit 3278. A match between the two sets of valid bits indicates that the associated instructions are to be applied to the same execution unit and therefore are in conflict. When a conflict is found, control signals are applied to register/gate 3277. The application of the control signals prevents the associated execution packet (or execution packets) from being forwarded to the dispatch crossbar unit 22. Therefore, when the execution packet from register/gate 3276 and register/gate 3277 are forwarded to the dispatch crossbar unit 22, no conflicting instructions are present.

2. Operation of the Preferred Embodiment

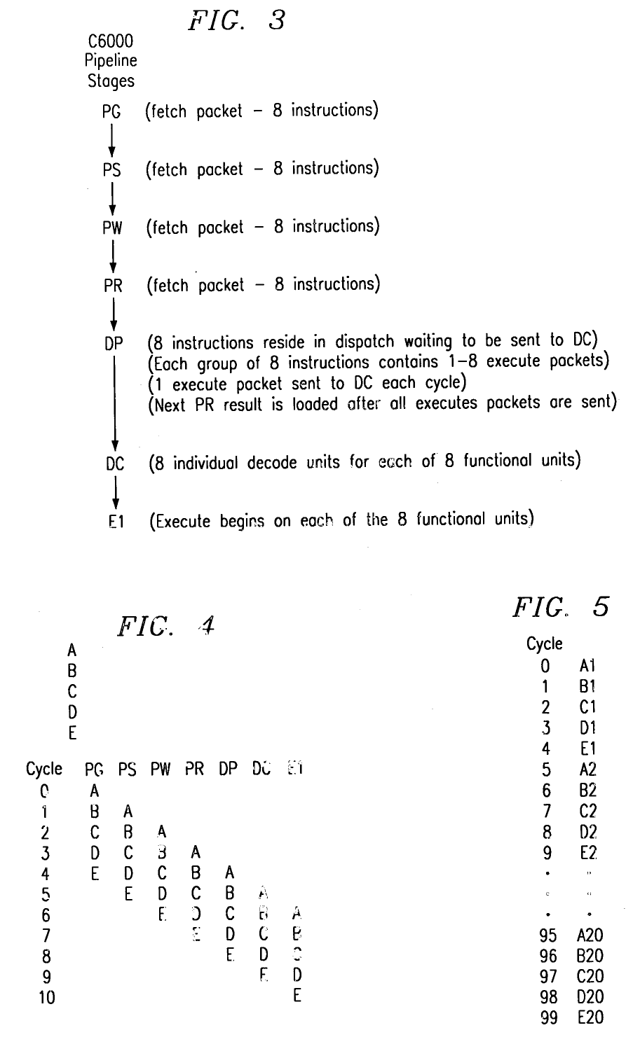

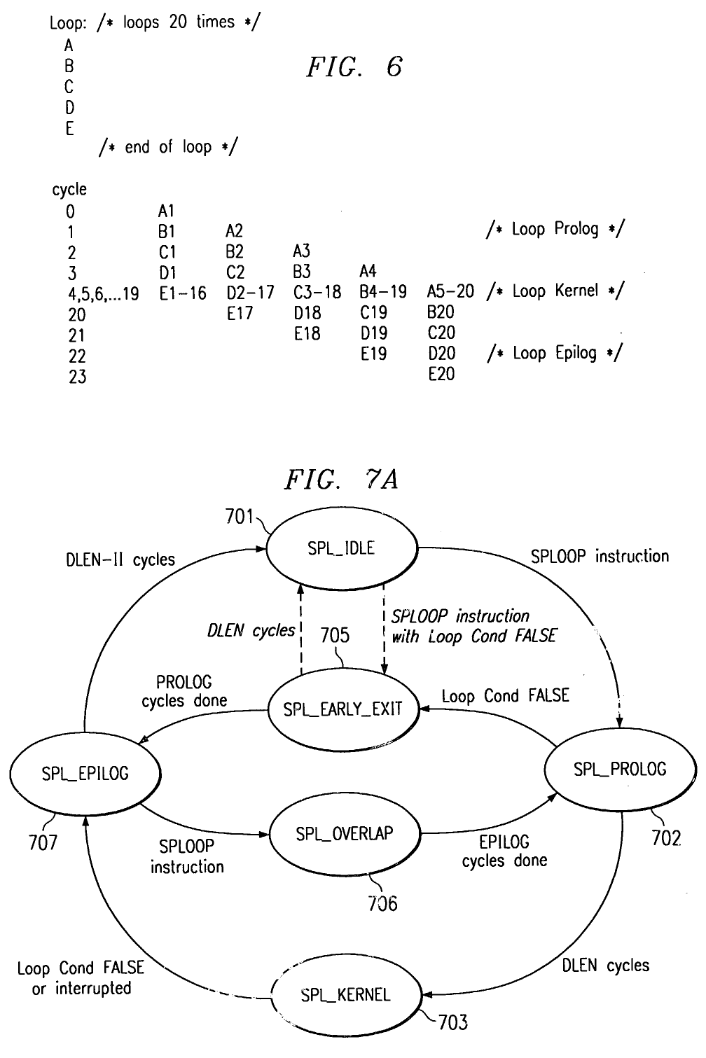

The operation of the apparatus of FIG. 5 can be understood in the following manner. The instruction stream transferred from the program memory/cache unit 31 to the program memory controller 30 includes a sequence of instructions. The software pipeline is initiated when the program memory controller identifies the SPLOOP instruction. The SPLOOP instruction is followed by series of instructions. The series of instructions as shown in FIG. 8 has length known as the dynamic length (DynLen). This group of instructions is divided into fixed interval groups having a length called an initiation interval (ii). The dynamic length divided by the initiation interval (DynLen/ii) provides the number of instruction stages. Because the three parameters are interrelated, only two need be specified as arguments by the SPLOOP instruction. In addition, the number of times that the series of instruction is to be repeated is also specified in the SPLOOP instruction. The number of stages must be less than the size of the dispatch buffer.

As will be clear, several restrictions are placed on the structure of each of the instruction stages. The stages are structured so that all of the stages of the instruction group can be executed simultaneously, i.e., that no conflict for resources be present. The number of instructions in each stage is the same to insure that all of the results of the execution of the various stages are available at the same time. These restrictions are typically addressed by the programmer in the formation of the instruction stages.

In executing a nested loop instruction set, the execution is enhanced using the software pipeline loop procedure each time the inner loop is executed. However, each time that the software pipeline procedure is invoked, the inner loop instructions must be retrieved from the program memory/cache unit 31. In order to enhance the execution of the nested loop instruction set, the inner loop instruction set can be retained in the dispatch buffer register unit 326 (and the valid bits in the sequential register file) while the outer loop instruction stages are executed. Then, when the inner loop instruction stages are to be executed, the inner loop instruction stages are applied to the program decode/execution units 23/24 from the dispatch buffer register unit 326. The input register 3251 can be used to control the signals from the dispatch buffer register unit 326. The signals from the dispatch buffer unit 326 are applied to the program decode/execution units 23/24 that results in the typical SPL_PROLOG state procedure. When the final stage as been applied to the dispatch crossbar unit 22, the SPL_KERNEL state will be implemented. When the final inner loop stage is executed in the SPL_KERNEL state, the dispatch buffer register unit 326 will implement the procedures of the SPL_EPILOG state and the contents of the dispatch buffer register unit 326 can be deleted.

In the event of conflicting instructions during the overlapping inner loop and outer loop instruction execution, the conflict is resolved by the apparatus of FIG. 16. Note that the activity performed by the inner loop instruction or instructions that are prevented from reaching the crossbar unit must be performed by the corresponding instruction from the conflicting outer loop instruction if the result of the inner loop instruction is required for correct program execution.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A multiple execution unit processor, the processor comprising:
a memory unit storing a plurality of execution packets;
a buffer storage unit for storing the execution packets;
a dispatch unit for directing each instruction of and execution packet applied thereto to an preselected execution unit;
a program memory control unit for retrieving execution packets from the memory unit, the program memory unit having a first state wherein an execution packet from the memory unit is applied to the dispatch unit and to the buffer storage unit, the execution packet applied to the execution unit being stored therein, wherein in the first state the retrieved instruction stage and any instruction stage stored in the buffer storage unit are applied to the dispatch unit simultaneously, the program control memory unit having a second state wherein the execution packets stored in the buffer storage unit are simultaneously applied to the dispatch unit, the program control memory unit having a third state implemented after a selected execution packet has been executed a predetermined number of times, wherein in the third state after the earliest stored execution packet in the buffer storage unit is eliminated after each application of the stored execution packets to the crossbar unit, wherein the processor uses the three instruction states to executes an inner loop of a nested-loop instruction set, the inner loop instruction set and an outer loop instruction set having overlapping execution;
a comparison unit receiving signals from the buffer storage unit and the program memory control unit, the comparison unit generating control signals; and
a gate unit responsive to the control signals for preventing an associated instruction for being applied to the dispatch unit.

2. The processor as recited in claim 1 wherein the comparison unit compares valid bits from the buffer storage unit with valid bits from the program memory control unit.

3. The processor as recited in claim 2 wherein the inner loop execution packets are stored in the buffer storage unit during execution of the outer loop instruction stages.

4. The processor as recited in claim 2 further comprising a second buffer storage unit, wherein the outer loop instruction stages are stored in the second buffer storage unit, the comparison unit receiving signals from the second buffer unit instead of the program memory control unit.

5. A method of executing a nested-loop set of instruction stages, the execution including the execution of outer loop instruction stages a first plurality of times, the execution of the nested loop of instructions including execution of inner loop instruction stages a second plurality of times for each execution of the outer loop of instruction stages, the method comprising:
using a software pipeline procedure to execute the inner loop instruction stages for each execution of the inner loop instructions the second plurality of times:
overlapping execution the inner loop instruction stages and the outer loop instruction stages;
comparing valid bits from the inner loop execution packets with valid bits from outer loop execution packets for execution packets that will be executed simultaneously; and
when the valid bits are the same, preventing the associated instruction from the buffer unit from being executed.

6. The method as recited in claim 5 further comprising:
storing the inner loop instruction stages in a buffer storage unit during the execution of the outer loop instruction set.

7. The method as recited in claim 5 further comprising:
storing the outer loop instruction stages in a buffer memory unit during execution of the inner loop instruction stages.

8. The method as recited in claim 7 wherein storing the outer loop instruction stage includes executing the outer loop instruction stages in a new sequence, the outer loop instruction stages executed after execution of the inner loop instruction stages being executed in the sequence before the execution of the outer loop instruction stages executed before the execution of the inner loop instruction stages in the new sequence.

9. The method as recited in claim 5 wherein the outer loop instruction set can have a instruction conflict with one of the inner loop states selected from the group consisting of the prolog state and the epilog state.

10. In a multi-execution unit processing unit for processing a nested loop instruction set, the inner loop instruction set being execution by a software pipeline procedure, the inner loop instruction set being stored in a buffer memory unit, execution of outer loop execution packets overlapping execution of the inner loop execution packets, apparatus for preventing conflict between an instruction in an outer loop execution packet and an instruction of the inner loop, the apparatus comprising:
a comparison unit for comparing valid bits from an outer loop execution packet with valid bits from an inner loop execution packet when the execution packets are executed simultaneously, when at least one valid bits from each execution packet is the same, generating control signals indicative of the conflicting instructions; and
a gate unit responsive to the control signals for preventing the conflicting instruction in the inner loop instruction set from being forwarded for execution.

11. The apparatus as recited in claim 10 wherein the function of the instruction prevented from being forwarded is included in the conflicting outer loop instruction.

12. In a multi-execution unit processing unit for processing a nested loop instruction set, the inner loop instruction set being execution by a software pipeline procedure, the inner loop instruction set being stored in a buffer memory unit, execution of outer loop execution packets overlapping execution of the inner loop execution packets, a method for preventing conflict between an instruction in an outer loop execution packet and an instruction of the inner loop, the method comprising:
comparing valid bits from the inner loop execution packets with outer loop execution packets for execution packets to be executed simultaneously; and
when valid bits associated with each instruction are the same for an instruction in both execution packet to be executed simultaneously, preventing the instruction with the same valid bit in the inner loop instruction set from being executed.

14. The method as recited in claim 13 wherein the functionality of instruction prevented from being executed is included in the outer loop instruction for which the conflict is identified.
